(19) United States
(12) Patent Application Publication
(10) Pub. No.: US 2023/0196476 A1
(43) Pub. Date: Jun. 22, 2023

(54) PORTFOLIO OPTIMIZATION SYSTEM THAT SIMULTANIOUSLY SUPPORTS MULTIPLE TAX-EXEMPT, TAX-DEFERRED AND TAXABLE ACCOUNTS

(71) Applicant: Morningstar, Inc., Chicago, IL (US)

(72) Inventors: Thomas M. Idzorek, Zephyr Cove, NV (US); Paul D. Kaplan, Toronto (CA); Jeffrey M. Sostrin, Chicago, IL (US)

(73) Assignee: Morningstar, Inc., Chicago, IL (US)

(21) Appl. No.: 17/926,923

(22) PCT Filed: Jun. 2, 2021
(86) PCT No.: PCT/US2021/035525

§ 371 Date: Nov. 21, 2022

Related U.S. Application Data
(60) Provisional application No. 63/034,139, filed on Jun. 3, 2020.
(60) Provisional application No. 63/196,055, filed on Jun. 2, 2021.

(51) Int. Cl. G06Q 40/10; G06Q 40/06

(52) U.S. Cl. CPC G06Q 40/10; G06Q 40/06

(57) ABSTRACT

The disclosed embodiments relate to a system that optimizes an investment portfolio across multiple investment accounts with differing tax treatments. During operation, the system receives a call to optimize the portfolio for an investor. First, the system solves for a target asset allocation that specifies a desired allocation for investments in each account type in the portfolio across different asset classes or factor exposures. Next, the system performs a portfolio optimization operation to determine the optimal allocations across different investment options for all accounts in the portfolio with the objectives of maximizing expected after-tax alpha for the portfolio, minimizing a tracking error between the portfolio and the target asset allocation, minimizing taxes on realized capital gains, both now and in the future (for taxable accounts), and minimizing trade costs. Finally, the system generates a set of trading instructions to produce the optimal allocation from a current allocation for the portfolio.

### CROSS-REFERENCE TO RELATED APPLICATION

This application claims the benefit of U.S. Provisional Patent Application Ser. No. 63/034,139, entitled “Manager Structure Optimization with Taxable, Tax-Deferred and Tax-Exempt Accounts,” by inventor Thomas M. Idzorek, filed on 3 Jun. 2020, the contents of which are incorporated by reference herein.

### BACKGROUND

### Field

The disclosed embodiments generally relate to the design of computer-based systems for managing investment portfolios and executing associated trading operations. More specifically, the disclosed embodiments relate to the design of a portfolio optimization system that simultaneously supports multiple tax-exempt, tax-deferred and taxable accounts in which the primary investments are pooled investment vehicles (e.g., mutual funds, ETFs, separate account, etc.).

### Related Art

For many investment professionals, a challenge is the determination of how much money to invest with each of the available funds or managers across multiple accounts, especially when the accounts are subject to different tax treatments. Other key challenges include determining when to replace an existing fund, when to move money from one fund to another, when to use passive versus active funds to maximize after-fee expected returns, and when to rebalance. Moreover, in a taxable setting additional challenges arise, such as where to locate different funds (tax-exempt, tax-deferred, or taxable accounts), when to roll-over money from one account to another (e.g., 401K plan to IRA), how to minimize taxes, how to minimize trading-costs, and how to personalize a portfolio based on an investor's non-pecuniary preferences, such as preferences for investments that are more environmentally, socially, and governance (ESG) friendly.

To address these challenges, it is desirable to be able to provide an automated system, which investment professionals can easily access, to simultaneously and holistically make these determinations. However, constructing such an automated system involves a number of challenges. This type of automated system will need to gather the necessary investment-related information from disparate sources, and then perform a tax-efficient optimization operation across all of an investor's accounts to produce an optimal asset allocation that tracks a desired target asset allocation. The automated system also needs to produce a set of trading instructions to achieve this optimal asset allocation.

Hence, what is needed is an automated system that effectively addresses these portfolio-optimization-related challenges within a single, holistic optimization.

### SUMMARY

The disclosed embodiments relate to a system that optimizes an investment portfolio across multiple investment accounts with differing tax treatments. During operation, the system receives a call to optimize the portfolio for an investor. First, the system solves for a target asset allocation that specifies a desired allocation for investments in each account type in the portfolio across different asset classes or factor exposures. Next, the system performs a portfolio optimization operation to determine the optimal allocations across different investment options for all accounts in the portfolio with the objectives of maximizing expected after-tax alpha for the portfolio, minimizing a tracking error between the portfolio and the target asset allocation, minimizing taxes on realized capital gains, both now and in the future (for taxable accounts), and minimizing trade costs. Finally, the system generates a set of trading instructions to produce the optimal allocation from a current allocation for the portfolio.

In some embodiments, the portfolio optimization system automatically executes the set of trading instructions to produce the optimal allocation.

In some embodiments, the portfolio optimization system receives an approval for the set of trading instructions from the investor or the investor's financial advisor prior to executing the set of trading instructions.

In some embodiments, the call to the portfolio optimization system is triggered by a scheduler on a periodic basis or in response to a non-periodic event.

In some embodiments, the call to the portfolio optimization system is received through an application programming interface (API) from a system belonging to an investment company, a financial advisor firm, a bank and/or a retirement account recordkeeper.

In some embodiments, the call to the portfolio optimization system does not include any personally identifiable information (PII) of the investor and the portfolio optimization operation does not consider any PII of the investor.

In some embodiments, the core optimization engine within the portfolio optimization system is stateless.

In some embodiments, the multiple investment accounts with differing tax treatments comprise different account types, including one or more of the following: a tax-exempt account; a tax-deferred account; and a taxable account.

In some embodiments, the portfolio optimization system incorporates a cash flow approach, which approximates a multi-period model using a single-period model by considering cash flows related to taxes and trade costs during an expected holding period for an investment and at the end of the expected holding period.

In some embodiments, the portfolio optimization system makes use of a tax-aware alpha value for each investment option.

In some embodiments, the portfolio optimization system recursively considers possible tax-loss harvesting operations based on individual tax lots in the current allocation for the portfolio to minimize taxes on capital gains.

In some embodiments, the portfolio optimization system decomposes the target asset allocation into a set of separate account-type specific allocation targets, and while doing so locates tax-inefficient investment options in tax-privileged accounts and tax-efficient investment options in taxable accounts.

In some embodiments, the portfolio optimization system considers individual tax brackets and associated tax rates for the investor.

In some embodiments, the portfolio optimization system considers trading costs for each investment option.

In some embodiments, the portfolio optimization system considers non-pecuniary investment preferences of the investor.

In some embodiments, the portfolio optimization system includes a desired withdrawal amount to produce an optimal allocation after the desired withdrawal amount is taken from the portfolio.

In some embodiments, the portfolio optimization system facilitates an account rollover by considering a possible rollover of a retirement account to another type of retirement account.

In some embodiments, the portfolio optimization system uses an asset class covariance matrix to compute an expected variance for the optimal allocation.

In some embodiments, multiple accounts considered in the portfolio optimization system can be distributed across multiple investment companies and/or retirement account recordkeepers.

In some embodiments, the investment options considered by the portfolio optimization system include one or more of the following: an equity security, a fixed-income security, a real estate investment trust (REIT) security, a money market fund, an index fund, an exchange-traded fund (ETF), a separately managed account, an investment fund associated with a specific fund manager, and cash.

### BRIEF DESCRIPTION OF THE FIGURES

FIG. 1 illustrates a portfolio optimization system in accordance with the disclosed embodiments.

FIG. 2A illustrates a portion of an exemplary schema for a call creator component's API for the portfolio optimization system in accordance with the disclosed embodiments.

FIG. 2B illustrates another portion of the schema for the API in accordance with the disclosed embodiments.

FIG. 2C illustrates another portion of the schema for the API in accordance with the disclosed embodiments.

FIG. 2D illustrates another portion of the schema for the API in accordance with the disclosed embodiments.

FIG. 2E illustrates another portion of the schema for the API in accordance with the disclosed embodiments.

FIG. 3 illustrates exemplary cost basis information and purchase date information for a set of tax lots in accordance with the disclosed embodiments.

FIG. 4 presents a flow chart illustrating the process of optimizing a portfolio across multiple investment accounts with differing tax treatments in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules.

For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Portfolio Optimization System

The heart of the portfolio optimization system is a provider-hosted, multi-account, fund-of-funds core optimization engine that simultaneously finds the ideal investment-specific allocations across the advisable accounts. The cloud-based core optimizer engine is called via an application programming interface (API) in which all of the required case-specific inputs are specified in a file using JavaScript Object Notation (JSON). This “core optimizer engine” can include any type of internally-developed or third-party-provided optimization engine that produces a portfolio allocation by optimizing an objective function. This can include, but is not limited to, optimizers that make use of use of quadratic, linear or non-linear programming techniques as well as stochastic-optimization techniques and gradient-descent techniques.

In general, the JSON file can identify: (1) the investor's current accounts and account types; (2) the current holdings and values within each account; (3) the cost basis and acquisition date for holdings in taxable accounts; (4) the trading costs associated with each account; (5) one of, (a) the target equity level for the considered accounts and years-to-retirement, (b) the detailed target asset allocation for the considered accounts, or (c) the detailed target asset allocation for each account type (tax-exempt, tax-deferred, taxable); (6) a curated list (“buy list”) of the best available investment options for each account; (7) any cash inflow or outflow (withdrawal amount); (8) the investor's current income and capital gains tax rates and expected income tax rate at the time of withdrawals; (9) the maximum amount of taxable gains the investor is willing to realize; and (10) whether money in the same account types is fungible (e.g., can tax-deferred 401k money be moved to a tax-deferred IRA).

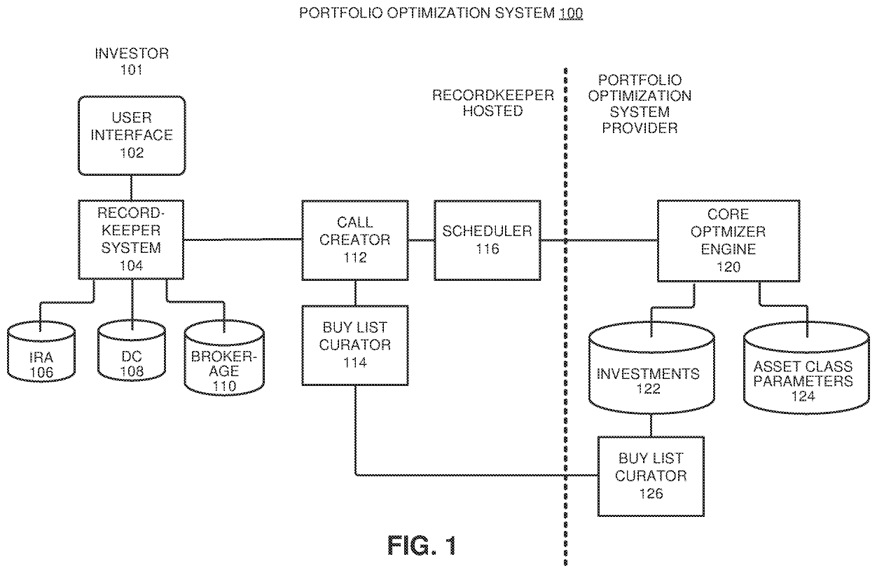

FIG. 1 illustrates the major components of the multi-account portfolio optimization system 100 in which the recordkeeper/provider prefers the flexibility of owning the pieces they host. The left-hand side of FIG. 1 includes components that are hosted by a retirement account recordkeeper (or investment company) that makes calls to the system. These components include: a recordkeeper system 104, a scheduler 116 for regularly making calls to the system (this enables tax-loss harvesting); a call creator component 112 for constructing valid API calls using JSON; and a recordkeeper-side buy list curator component 114 that calls a provider-side buy list curator component 126, which accesses an investments database 122 to narrow down a large universe of potential investments options to create a “curated buy list.”

Recordkeeper system 104 performs various ongoing operations for a retirement account recordkeeper (or some other type of investment company). These ongoing operations involve interacting with an investor 101 through a user interface 102, and performing various operations, which access: an individual retirement account (IRA) database 106, a defined-benefit (DC) database 108 and a more-general brokerage database 110. (Note that in some instances investors could have accounts at different firms and some sort of aggregation system would be used.)

The right-hand side of FIG. 1 includes the major components that are hosted by the portfolio optimization system provider. These components include: an investments database 122; an asset class parameters database 124; a core optimizer engine 120; and the provider-side buy list curator component 126. Investments database 122 is regularly updated and contains: tax-exempt (pre-tax) forward-looking alphas (wherein alphas are excess returns relative to a custom benchmark); investment-specific-risk (residual or idiosyncratic tracking error); and estimated asset class exposures for open mutual funds, ETFs, individual equities, individual bonds, and variable annuity sub-accounts. As such, investments database 122 covers the vast majority of investment options offered on typical taxable and IRA investment platforms. Hence, with proper connections and permissions, the multi-account portfolio optimization system 100 can simultaneously optimize accounts without the need to consolidate assets with a single provider.

Asset class parameters database 124 contains a variety of inputs generated by the portfolio optimization system provider that are used during the optimization. This can include a forecasted asset class variance-covariance matrix as well as forecasts of the percentage of total returns that will be generated from long-term capital appreciation versus dividend and income for each asset class. This latter decomposition of total returns is coupled with investor-specific tax rates and investment-specific turnover information to modify or transform a starting pre-tax forward-looking alpha estimate into investor-specific, investment-specific after-tax forward-looking alphas. (The other inputs are modified accordingly.) Having distinct inputs for the same investment option based on account-type (tax-exempt versus tax-deferred versus taxable) is one of the innovations we use to optimize for overall tax efficiency and a tax-efficient asset location.

### Scheduler

Given the nature of this required functionality, we believe many investment companies or retirement account recordkeepers will find it advantageous to leverage elements of their existing capabilities. In most cases, the provider will have some form of a “scheduler” 116 that periodically calls the multi-account portfolio optimization system for an updated recommendation. Regardless of who creates scheduler 116, key reasons to seek a new recommendation include:
significant amounts of money are being added to or subtracted from one or more of the accounts (this could be the result of required minimum withdrawals);
market volatility may provide an opportunity to harvest a tax loss;
market volatility has caused the amount in each investment to drift away from its recommended weight;
available investment options have changed (this is most significant for defined-contribution (accounts in which there is a planned line-up change to a core investment option);
the target asset allocation for the investor has changed; and
the investor's tax bracket and income tax rates have changed.

Scheduler 116 can be time-based, event-based, or a combination. A time-based scheduler simply calls the multi-account portfolio construction system at predetermined intervals, e.g., daily, weekly, monthly, etc. In some instances, it might even be done intra-day. Note that a daily frequency is more likely to harvest potential tax-losses than a weekly or monthly frequency. For example, within a week or a month, the price of an investment could potentially plummet during a market selloff and then bounce back a couple days later. The provider needs to determine the right balance between the potential investment benefits of a daily or weekly frequency versus the operational complexities of re-optimizing frequently.

An event-based scheduler 116 is triggered when certain criteria are met. A common event is when an investor logs-in to their account(s), which in general should trigger a call to the portfolio optimization system. Another type of event could be generated by the system that cycles through a book of business to find taxable accounts having investments with a value below their current cost basis. In this way, all of the advisable accounts of a given investor could be re-optimized with a high likelihood of identifying an opportunity to harvest a tax loss. Note that it may be easier to simply re-optimize the entire book of business daily than to locate a subset of investors with one or more accounts with a potential tax loss.

### Call Creator

The call creator component 112, which is implemented as an API that accepts data in JavaScript Object Notation (JSON) format, is used to make calls to optimize a portfolio for an investor. In a multi-account situation, the provider may need to gather information on different account types for the investor from separate internal systems, e.g., a DC system, an IRA system, and a taxable brokerage system. With advances in account aggregation, it may even be possible to pull in information on accounts held at other providers and then consider those holdings even if they are designated as unadvisable.

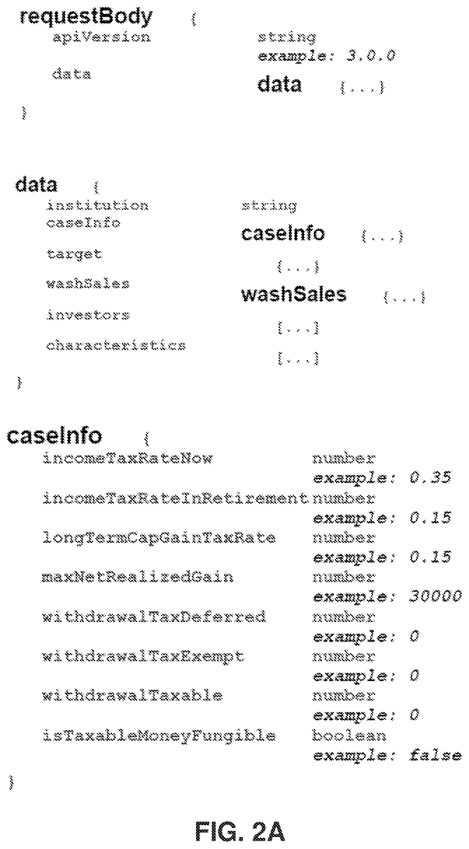

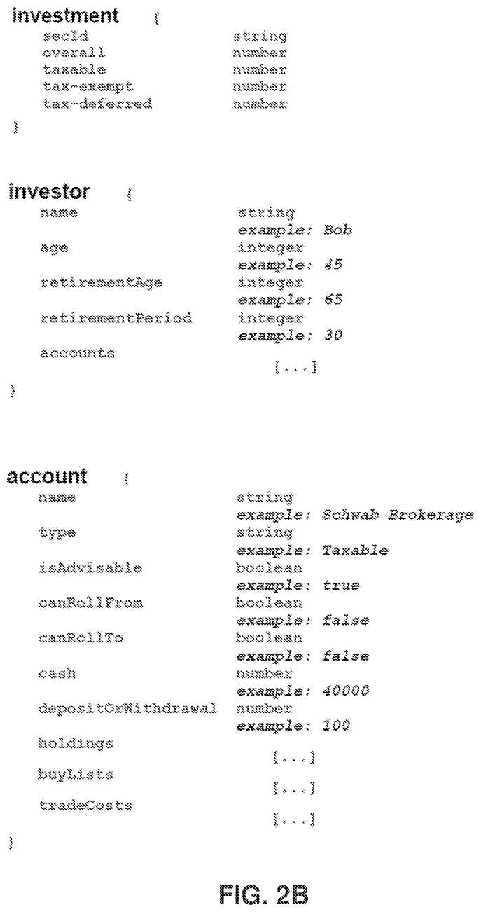

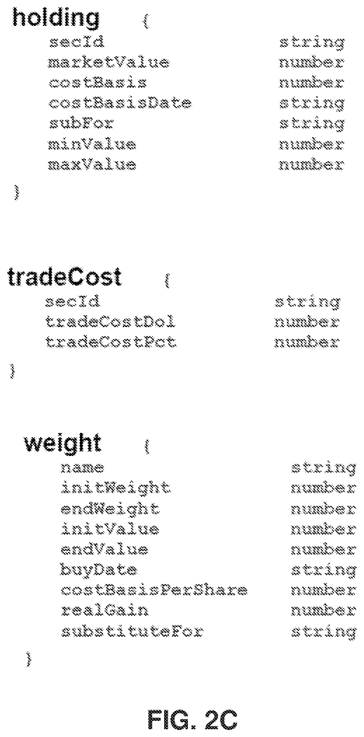

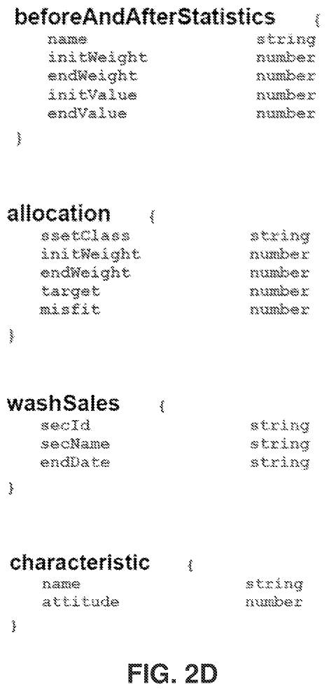

Once all of the necessary data is available, it needs to be specified using JSON in a manner that corresponds to the schema of the portfolio optimization system's API. The images in FIGS. 2A-2E provide exemplary JSON schemas with associated fields for the call creator component's 112 API.

### Buy List Curator

Most defined-contribution plan line-ups include a relatively manageable number of investment options, all of which can be presented to the portfolio optimization system for possible allocation. In contrast to such retirement plan line-ups, most IRA and brokerage platforms have thousands of investment options. In these cases, it best to evaluate all of the investment options and create a curated subset of investment options to include in the optimization.

Initially, this process will likely be manual. The recordkeeper will simply send the portfolio optimization system provider a spreadsheet with a list of available funds for each available platform and the portfolio optimization system provider will send back the corresponding buy lists.

Alternatively, in an auxiliary application within the broader multi-account portfolio construction system, we can establish a separate buy list curator component 114 that provides an API in which JSON is used to pass a large list of unique investment identifiers to the portfolio optimization system provider's system, which will return a curated buy list.

### The Core Optimizer Engine

As mentioned above, the portfolio optimization system provider hosts the core optimizer engine 120 and a provider-side buy list curator component 126, which narrows down large investment lists into smaller buy lists. Upon receiving an API call from call creator component 112, the structure of the JSON file is first validated to ensure that it conforms to the API, and the core optimizer engine 120 is executed. The core optimizer engine 120 then returns (or pushes back) the recommend investment-specific allocation for each account belonging to the investor as well as associated trading instructions. In some embodiments, the core optimizer engine 120 is “stateless,” which means that core optimizer engine 120 operates on a set of inputs received through its API and produces a corresponding set of outputs without storing any state information that persists between successive calls.

Note that the recordkeeper may have to address various challenges based on the recommendations. For example, the recordkeeper may have to deal with the fact that ETFs trade intra-day, while mutual funds only trade once at the end of the day.

### Gathering the Inputs

We now provide further details on the inputs that are included in the JSON file that is passed to the core optimizer engine 120. We also provide guidance on the different sources for that information and what to do when the information is unavailable.

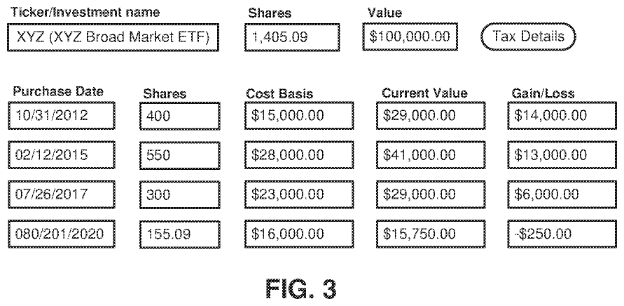

For taxable accounts, the portfolio optimization system's provider's system will ideally have accurate cost basis and purchase date information for all tax lots as is illustrated in FIG. 3. If there is missing data, the recordkeeper's system will need to address this prior to making a call to the multi-account portfolio construction system. For example, the recordkeeper's system can provide a user interface that presents the investor with choices related to missing data. For example, in the case of a missing cost basis for an asset, the recordkeeper's system can provide a user interface that enables the investor to select among the following options: (1) do not trade the asset; (2) use an approximate cost basis based on an estimated purchase date; and (3) provide an investor-estimated cost basis. Given the real-world implications of making decisions based on inaccurate information, the recordkeeper should address missing data in a manner they are comfortable with. The safest option may be to simply restrict the selling of a taxable investment with missing tax information.

### Methodology

The optimization methodology employed by the core optimizer engine 120 is described in more detail in a document entitled “Fund-of-Funds Optimization with Tax-Exempt, Tax-Deferred and Taxable Accounts,” by Thomas M. Idzorek, which is incorporated into U.S. Provisional Patent Application No. 63/196,055 filed 2 Jun. 2021, which is hereby incorporated by reference.

### Process

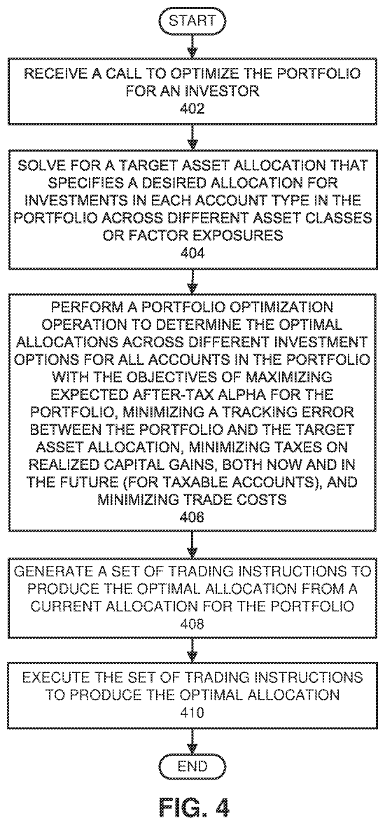

FIG. 4 presents a flow chart illustrating the process of optimizing a portfolio across multiple investment accounts with differing tax treatments in accordance with the disclosed embodiments. During operation, the portfolio optimization system receives a call to optimize the portfolio for an investor (step 402). First, the system solves for a target asset allocation that specifies a desired allocation for investments in each account type in the portfolio across different asset classes or factor exposures (step 404). Next, the system performs a portfolio optimization operation to determine the optimal allocations across different investment options for all accounts in the portfolio with the objectives of maximizing expected after-tax alpha for the portfolio, minimizing a tracking error between the portfolio and the target asset allocation, minimizing taxes on realized capital gains, both now and in the future (for taxable accounts), and minimizing trade costs (step 406). The system then generates a set of trading instructions to produce the optimal allocation from a current allocation for the portfolio (step 408). Finally, the system automatically executes the set of trading instructions to produce the optimal allocation (step 410).

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for using a portfolio optimization system to optimize an investment portfolio across multiple investment accounts with differing tax treatments, comprising:
receiving a call to optimize the portfolio for an investor;
solving for a target asset allocation that specifies a desired allocation for investments in each account type in the portfolio across different asset classes and/or factor exposures;
performing a portfolio optimization operation to determine the optimal allocations across different investment options for all accounts in the portfolio with one or more of the objectives of maximizing expected after-tax alpha for the portfolio, minimizing a tracking error between the portfolio and the target asset allocation, minimizing taxes on realized capital gains, both now and in the future for taxable accounts, and minimizing trade costs; and
generating a set of trading instructions to produce the optimal allocation from a current allocation for the portfolio.

2. The method of claim 1, wherein the method further comprises automatically executing the set of trading instructions to produce the optimal allocation.

3. The method of claim 1, wherein the method further comprises receiving an approval for the set of trading instructions from the investor (or the investor's advisor) prior to executing the set of trading instructions.

4. The method of claim 1, wherein the call is triggered by a scheduler on a periodic basis or in response to a non-periodic event.

5. The method of claim 1, wherein the call is received through an application programming interface (API) from a system belonging to an investment company, a financial advisor firm, a bank and/or a retirement account recordkeeper.

6. The method of claim 1, wherein the call does not include any personally identifiable information (PII) of the investor and the portfolio optimization operation does not consider any PII of the investor.

7. The method of claim 1, wherein the optimization operation is performed by a stateless core optimizer engine.

8. The method of claim 1, wherein the multiple investment accounts with differing tax treatments include comprise different account types, including one or more of the following:
a tax-exempt account;
a tax-deferred account; and
a taxable account.

9. The method of claim 1, wherein the portfolio optimization system incorporates a cash flow approach, which considers cash flows related to taxes and trade costs during an expected holding period for an investment and at the end of the expected holding period.

10. The method of claim 1, wherein the portfolio optimization system makes use of a tax-aware alpha value for each investment option.

11. The method of claim 1, wherein the portfolio optimization system recursively considers possible tax-loss harvesting operations based on individual tax lots in the current allocation for the portfolio to minimize taxes on capital gains.

12. The method of claim 1, wherein the portfolio optimization system decomposes the target asset allocation into a set of separate account-type specific allocation targets, and while doing so locates tax-inefficient investment options in tax-privileged accounts, and tax-efficient investment options in taxable accounts.

13. The method of claim 1, wherein the portfolio optimization system considers individual tax brackets and associated tax rates for the investor.

14. The method of claim 1, wherein the portfolio optimization system considers trading costs for each investment option.

15. The method of claim 1, wherein the portfolio optimization system considers non-pecuniary investment preferences of the investor.

16. The method of claim 1, wherein the portfolio optimization system includes a desired withdrawal amount to produce an optimal allocation after the desired withdrawal amount is taken from the portfolio.

17. The method of claim 1, wherein the portfolio optimization system facilitates an account rollover by considering a possible rollover of a retirement account to another type of retirement account.

18. The method of claim 1, wherein the portfolio optimization system uses an asset class covariance matrix to compute an expected variance for the optimal allocation.

19. The method of claim 1, wherein the multiple accounts considered by the portfolio optimization system can be distributed across multiple investment companies and/or retirement account recordkeepers.

20. The method of claim 1, wherein the investment options considered by the portfolio optimization system include one or more of the following:
an equity security;
a fixed-income security;
a real estate investment trust (REIT) security;
a money market fund;
an index fund;
an exchange-traded fund (ETF);
a separately managed account;
an investment fund associated with a specific fund manager; and
cash.

21. A non-transitory computer-readable storage medium storing instructions that when executed by a computer cause the computer to perform a method for using a portfolio optimization system to optimize an investment portfolio across multiple investment accounts with differing tax treatments, the method comprising:
receiving a call to optimize the portfolio for an investor;
solving for a target asset allocation that specifies a desired allocation for investments in each account type in the portfolio across different asset classes and/or factor exposures;
performing a portfolio optimization operation to determine the optimal allocations across different investment options for all accounts in the portfolio with one or more of the objectives of maximizing expected after-tax alpha for the portfolio, minimizing a tracking error between the portfolio and the target asset allocation, minimizing taxes on realized capital gains, both now and in the future for taxable accounts, and minimizing trade costs; and
generating a set of trading instructions to produce the optimal allocation from a current allocation for the portfolio.

22. The non-transitory computer-readable storage medium of claim 21, wherein the method further comprises automatically executing the set of trading instructions to produce the optimal allocation.

23. The non-transitory computer-readable storage medium of claim 21, wherein the method further comprises receiving an approval for the set of trading instructions from the investor (or the investor's advisor) prior to executing the set of trading instructions.

24. The non-transitory computer-readable storage medium of claim 21, wherein the call is triggered by a scheduler on a periodic basis or in response to a non-periodic event.

25. The non-transitory computer-readable storage medium of claim 21, wherein the call is received through an application programming interface (API) from a system belonging to an investment company, a financial advisor firm, a bank and/or a retirement account recordkeeper.

26. The non-transitory computer-readable storage medium of claim 21, wherein the call does not include any personally identifiable information (PII) of the investor and the portfolio optimization system does not consider any PII of the investor.

27. The non-transitory computer-readable storage medium of claim 21, wherein the optimization operation is performed by a stateless core optimizer engine.

28. The non-transitory computer-readable storage medium of claim 21, wherein the multiple investment accounts with differing tax treatments comprise different account types, including one or more of the following:
a tax-exempt account;
a tax-deferred account; and
a taxable account.

29. The non-transitory computer-readable storage medium of claim 21, wherein the portfolio optimization system incorporates a cash flow approach, which considers cash flows related to taxes and trade costs during an expected holding period for an investment and at the end of the expected holding period.

30. The non-transitory computer-readable storage medium of claim 21, wherein the portfolio optimization system makes use of a tax-aware alpha value for each investment option.

31. The non-transitory computer-readable storage medium of claim 21, wherein the portfolio optimization system recursively considers possible tax-loss harvesting operations based on individual tax lots in the current allocation for the portfolio to minimize taxes on capital gains

32. The non-transitory computer-readable storage medium of claim 21, wherein the portfolio optimization system decomposes the target asset allocation into a set of separate account-type specific allocation targets, and while doing so locates tax-inefficient investment options in tax-privileged accounts, and tax-efficient investment options in taxable accounts.

33. The non-transitory computer-readable storage medium of claim 21, wherein the portfolio optimization system facilitates an account rollover by considering a possible rollover of a retirement account to another type of retirement account.

34. A system that optimizes an investment portfolio across multiple investment accounts with differing tax treatments, comprising:
at least one processor and at least one associated memory; and
an optimization that executes on the at least one processor, wherein the optimization mechanism:
receives a call to optimize the portfolio for an investor;
solves for a target asset allocation that specifies a desired allocation for investments in each account type in the portfolio across different asset classes and/or factor exposures;
performs a portfolio optimization operation to determine the optimal allocations across different investment options for all accounts in the portfolio with one or more of the objectives of maximizing expected after-tax alpha for the portfolio, minimizing a tracking error between the portfolio and the target asset allocation, minimizing taxes on realized capital gains, both now and in the future for taxable accounts, and minimizing trade costs; and
generates a set of trading instructions to produce the optimal allocation from a current allocation for the portfolio.
